(19) United States
(12) Patent Application Publication
(10) Pub. No.: US 2009/0276259 A1
(43) Pub. Date: Nov. 5, 2009

(54) AGGREGATING RISK IN AN ENTERPRISE STRATEGY AND PERFORMANCE MANAGEMENT SYSTEM

(76) Inventor: Karol Bliznak, Walldorf (DE)

Correspondence Address: SCHWEGMAN, LUNDBERG & WOESSNER/SAP, P.O. BOX 2938, MINNEAPOLIS, MN, 55402, US

(21) Appl. No.: 12/114,536

(22) Filed: May 2, 2008

(51) Int. Cl. G06F 17/50

(52) U.S. Cl. 705/7

(57) ABSTRACT

A system for aggregating risk data in an enterprise strategy and performance management is provided. The system, in one example embodiment, includes a risk fetching module to obtain risk exposure data, the risk exposure data related to one or more objectives, a risk data parser to determine a first objective from the one or more objectives, a selector to determine source risk exposure values from the risk exposure data, the source risk exposure values being related to the first objective, an aggregator to aggregate the source risk exposure values related to the first objective into an aggregated risk value, and a mapping module to determine a performance goal corresponding to the first objective. A view generator may be provided to generate a combined view to include performance data related to the performance goal and the aggregated risk value.

### TECHNICAL FIELD

This disclosure relates generally to the fields of business performance optimization and risk management, and, more particularly, to aggregating risk in an enterprise strategy and performance management system.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

In order to function effectively in today's business environment, organizations often desire to have visibility of their business activities and operation performance at all times. Business performance management (BPM) has emerged as a critical discipline to enable enterprises to manage their business solutions in an “on-demand” fashion, so that the business solution may be updated in a quick and efficient manner in order to accommodate various demands in the marketplace. BPM techniques may provide a comprehensive view of business operation in the organization. Some computer-implemented BPM systems may be used advantageously to increase revenue by contributing to continuous improvement of business processes. BPM systems are designed for use by business managers and business strategy specialists.

Risk management consists of a systematic process for the identification, analysis and mitigation the project risks, aiming to minimize the probabilities of occurrence and/or the severity of the consequences of the adverse events to the objectives of the project. Improvements in risk management generally focus on the establishment of objective procedures that aim at risks reduction, creation of synergy between different areas for most complex risks mitigation and creation of more realistic vision of the main project deviations. In this way, the project team can try to identify and prevent undesired events with respect to a project, thereby minimizing the impact of negative events on the project. Some existing computer-implemented risk management systems are designed for use by risk managers and risk assessment specialists.

In order to determine, which of the company's strategic objectives are at risk (e.g., in order to effectively introduce and monitor risk mitigating measures) the data maintained by the company's BPM system may need to be manually rolled up and merged with the data maintained by the company's risk management system, e.g., using spreadsheets or slide decks.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing a network environment within which a method and system for aggregating risk in an enterprise strategy and performance management system may be implemented;

FIG. 2 is a block diagram illustrating an integration system, in accordance with an example embodiment;

FIG. 3 is a flow chart illustrating a method for aggregating risk in an enterprise strategy and performance management system, in accordance with an example embodiment;

FIG. 4 a flow chart illustrating a method for risk-adjusted strategy monitoring, in accordance with an example embodiment;

FIG. 5 is a diagrammatic representation of an architecture for a process to bring risk data into the context of strategy management, in accordance with an example embodiment;

FIG. 6 is a diagrammatic representation of an architecture for a process to load a data cube used by a strategy management system with risk data, in accordance with an example embodiment;

FIG. 7 is a diagrammatic representation of a user interface to display strategy management data, in accordance with an example embodiment;

FIG. 8 is a diagrammatic representation of a user interface to display a scorecard that incorporates risk data, in accordance with an example embodiment; and

FIG. 9 is a diagrammatic representation of a machine in the example form of a computer system within which a set of instructions, for causing the machine to perform any one or more of the methodologies discussed herein, may be executed.

### DETAILED DESCRIPTION

Many of today's businesses have a common theme: leveraging knowledge of enterprise risks and their own risk tolerance to guide strategy creation and measurement of performance in executing strategy. Organizations are altering their business model, designing new products, and cultivating new channels to prepare for the future and this strategic change is always accompanied by risks potentially affecting business performance in a negative way. Enterprise strategy and performance management (collectively referred to as strategy management) may strive to align resources quickly in order to carry out corporate strategy by communicating strategic plans clearly, translating them into priorities and tasks and rapidly monitoring and reporting on progress. Business performance and strategy-related entities include strategies, objectives, initiatives, key performance indicators, and scorecards.

An objective is a desired outcome of an organization's activity that may be expressed in a direction statement. Objectives may be aimed at encouraging the organization members to put in effort towards achieving the organization's strategy. For example, “Become a trusted advisor for fashion” may be set forth as one of strategic objectives of an organization operating in the fashion industry. Financial and non-financial metrics that are used to quantify (or measure) objectives and to reflect strategic performance of an organization may be referred to as key performance indicators (KPIs). KPIs represent past performance and also may be used as indicators future performance. For example, a quantitative KPI associated with customer loyalty rate may be used to measure the achievement of the objective “Become a trusted advisor for fashion.” Another concept for measuring whether an organization is meeting its strategic objectives is a so-called scorecard. Typically, a scorecard balances financial aspects with customer-process- and personnel-related outcomes as part of an organization's strategy. Strategies and objectives, as well as the associated key performance indicators and scorecards, may be defined at selected levels of an organization. Subsequently, they are documented as application data in a strategy management system to be monitored and reported on as part of the enterprise performance and strategy management process.

Strategy management is often affected by successes and shortcomings of risk management. Risk management may be effectuated by utilizing an enterprise risk management system (further referred to as risk management system). A risk management system may be used to document and evaluate business risks and their impact and probability (collectively referred to as risk data), as well as additional attributes and mitigating measures, in order to help the organization to manage risks and seize opportunities related to the achievement of strategic objectives. Risk data may be rolled up and reported as part of the enterprise risk management process. Risk may be thought of as an event having a potential negative impact on the achievement of strategic objectives. Risk may be defined by impact (e.g., denoted in financial terms) and probability. Risk exposure and expected loss values may be used to provide numeric values for various risks, such that risks may be evaluated and compared. Risk exposure, in one example embodiment, may be calculated as probability of the risk occurring and the value of the total loss if the risk occurs.

Strategy management and risk management may be related from a theoretical point of view, as both are related to strategic objectives and performance goals. However, in practice, strategy management and risk management are frequently handled separately. The two processes may be owned by different functional teams and may use different methodologies, different terminologies, and different supporting software applications (e.g., a strategy management computer-implemented system and a risk management computer-implemented system). A strategy management system may be configured to collect and report on strategy- and performance-related enterprise data, while a risk management system may be configured to collect and report on risk-related data. In the absence of a method or a system to match the performance and risk data from these separate organizational and system silos, company management may fail to perceive enterprise risks in the context of their organization's strategic objectives.

The inventor identified some shortcomings of a methodology that lacks consistent common platform for the business managers to find out the relationship between the strategic objectives and the associated risks. For example, lack of formalized association between performance and risk may make it necessary to dedicate substantial resources to manually determine those strategic objectives that may be subject to an increased (or increasing) risk exposure that may potentially prevent the respective business unit from achieving the objective. If the risk exposure indicator at the objective level is missing or available only in a separate, non-integrated source of data, the comparison of actual versus target performance indicator values (showing how well the respective objective is being achieved) may be the only predictor of future performance available to business managers in this context. However, this type of historical, comparison-based data may not be indicative of risks that have a potential to affect the organization's ability to achieve the objectives in the future. The lack of association between performance and risk may cause business managers to ignore potential risks (e.g., in cases when historical and present performance has been good) and, consequently, make biased conclusions about the future performance by a business unit.

Merely associating performance and strategic objectives with risk exposure values may not always be of use to business managers and strategy specialists when the association between performance and risk exists at a wrong level of granularity (e.g., where individual, too granular risks, are associated with operational Key Performance Indicators directly, without being previously aggregated). This approach might result in long lists (possibly up to hundreds) of individual risks associated with one performance indicator being assigned to one or more objectives of a business unit's strategic scorecard, which could confuse and overwhelm business managers who are typical consumers of the scorecard. These attempts do not distinguish between the roles of a business manager and a risk manager. On the one hand, a risk manager is a risk professional (and thus trained and experienced enough to be able to understand and navigate through the complexity of risk aggregation) who would typically work only with the risk aspects of the data, using a significant level of detail. On the other hand, a business manager is a general management professional, who typically understand the performance side as he or she is responsible for the execution of the strategy for the respective business unit. Thus, business managers may benefit from having access to aggregated indicators of whether the strategy of the unit they are responsible for is at risk.

The lack of the association between strategy and performance data and risk data or the association at a wrong level of granularity may result in allocating or investing inappropriate amount of resources (e.g., human, finance, computing, etc.) or in allocating resources in the wrong area of the business. The inventor identified the need for a more integrated periodical risk-adjusted strategy monitoring in order to efficiently and effectively align the execution of business strategy with risk management.

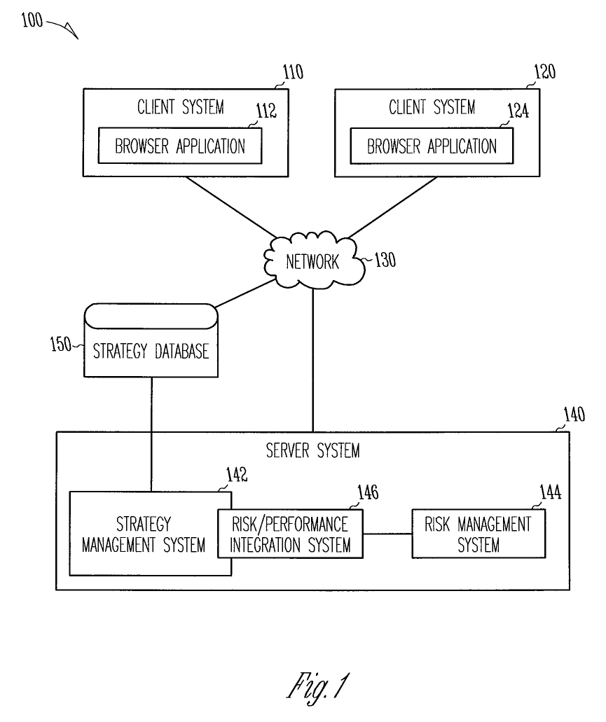

Method and system for aggregating risk data in an enterprise strategy and performance management are described. In one example embodiment, the method and system for aggregating risk data in an enterprise strategy and performance management system may be deployed by a business entity to align execution of business strategy with the ongoing enterprise risk management process. One example feature of the novel method and system is the ability to aggregate the expected loss metrics of individual risks into a single risk exposure indicator. Thus generated risk exposure indicator may be associated with a strategic objective or goal and then displayed in a combined view generated in the context of a strategy management system. In one example embodiment, the large number of individual risks are not necessarily all linked with a performance-related KPI assigned to a strategic objective. Instead, the method first determines what level of detail related to risk information may be appropriate in a given situation, aggregates risk data according to the determined level of detail, and then provides business managers or other users with the appropriate level of detail regarding the risk exposure of the strategic objectives. Thus, in one example embodiment, only data characterized by the desired granularity is being transferred between a risk management system and a strategy management system. Example system for aggregating risk in an enterprise strategy and performance management system may be described with reference to a network environment illustrated in FIG. 1.

FIG. 1 shows an example network environment 100, within which method and system for aggregating risk in an enterprise strategy and performance management system may be implemented. The network environment 100 may include client systems 110 and 120, which may host browser applications 112 and 124 respectively and a server system 140. The client systems 110 and 120 and the server system 140 may be in communications with each other via a network 130. The communications network 130 may be a public network (e.g., the Internet, a wireless network, a public switched telephone network (PSTN), etc.) or a private network (e.g., LAN, WAN, Intranet, etc.). The server system 140 may host a strategy management system 142 and a risk management system 144. The strategy management system 142 may be in communication with a strategy database 150.

As mentioned above, the strategy management system 142 may be configured for use by business managers that focus on strategic planning and performance monitoring. The risk management system 144, in turn, may be configured for use by risk management specialists. Also shown as part of the server system 140 is an integration system 146 to integrate risk data from the risk management system 144 with data from the strategy management system 142.

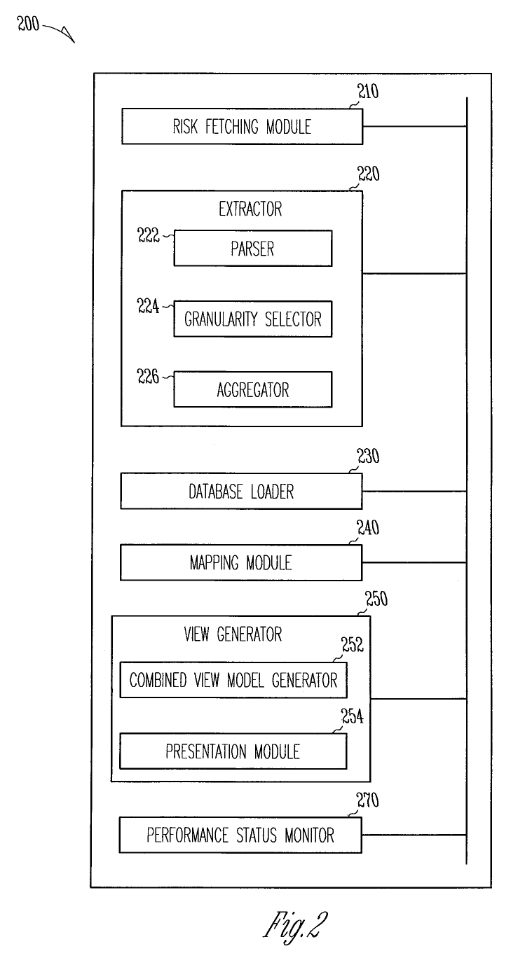

The integration system 146 may utilize one or more modules from the strategy management system 142, which is indicated in FIG. 1 by the integration system 146 being positioned as to overlap the strategy management system 142. The integration system 146 may be configured to have access to both risk data (e.g., data maintained by the risk management system 144) and to strategy and performance data (e.g., data maintained by the strategy management system 142). Example embodiment of the integration system 146 may be described with reference to FIG. 2.

FIG. 2 shows a block diagram illustrating an integration system 200, according to one example embodiment. As shown in FIG. 2, integration system 200 includes a risk fetching module 210, an extractor 220, a mapping module 240, and a view generator 250. The risk fetching module 210 may be configured to obtain, from the risk management system 144 of FIG. 1, risk exposure data. As mentioned above, the risk exposure data the risk management system 144 may be related to one or more objectives. The extractor 220 may be configured to process the obtained risk data. Specifically, extractor 220 may include a parser 222 (to determine one or more objective respectively related to portions of the risk data), a granularity selector 224 (to determine which risk exposure values from the risk exposure data correspond to or are related to the determined objectives respectively), and an aggregator 226 (to aggregate risk exposure values related to the same objective into a single value—an aggregated risk value). The mapping module 240 may be configured to match objectives associated with the obtained risk data with performance goals maintained by the strategy management system 142 of FIG. 1.

The view generator 250 may be configured to generate a combined view that includes performance data related to performance goals maintained by the strategy management system 142, as well as risk data aggregated for each objective that corresponds to at least one performance goal. The view generator 250 may include a combined view model generator 252 and a presentation module 254. The combined view model generator 252, in one example embodiment, may be configured to generate a multidimensional data cube based on the risk data and the associated performance data. Also shown in FIG. 2 is a performance status monitor 270 (that may also be referred to as a goal status monitor). The performance status monitor 270 may be configured to generate a goal status indicator (or performance status indicator based on the associated aggregated risk value and one or more performance indicators related to the performance goal. The risk data obtained by the risk fetching module 210 may be first loaded into the strategy database 150 of FIG. 150, utilizing a database loader 230 illustrated in FIG. 2.

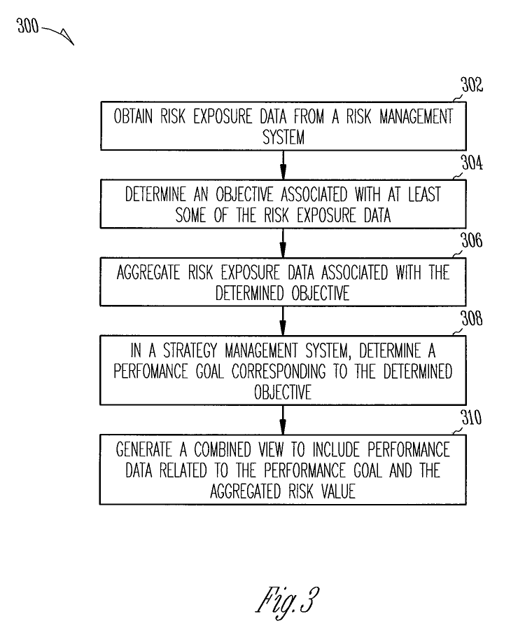

Some or all of the modules of the integration system 200 may be, in one example embodiment, part of the strategy management system 142 of FIG. 1. In an alternative embodiment, the integration system 200 may be a stand alone system or part of the risk management system 144 of FIG. 1. Various operations performed by the integration system 200, according to an example embodiment, may be discussed with reference to FIG. 3.

FIG. 3 is a flow chart illustrating a method 300 for aggregating risk in an enterprise strategy and performance management system, in accordance with an example embodiment. The method 300 may be performed by processing logic that may comprise hardware (e.g., dedicated logic, programmable logic, microcode, etc.), software (such as run on a general purpose computer system or a dedicated machine), or a combination of both. The processing logic, according to example embodiments, may reside in any of the modules shown in FIG. 2.

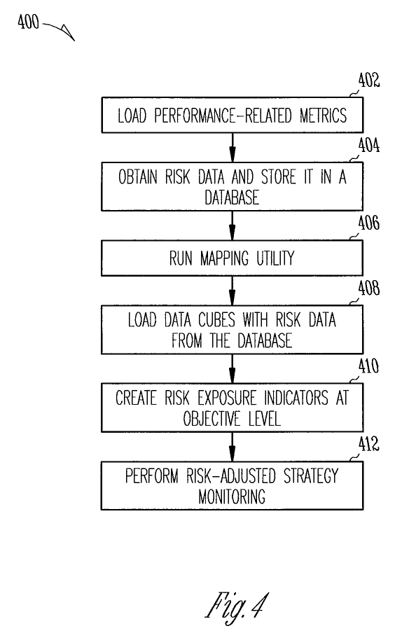

As shown in FIG. 3, the method 300 commences with operation 302, where the risk fetching module 210 of FIG. 2 obtains, from the risk management system 144 of FIG. 1, risk exposure data. At operation 304, the parser 222 determines an objective associated with at least some of the risk exposure data. At operation 304, the aggregator 226 aggregates risk exposure data related to the objective determined at operation 304 into an aggregated risk value. The mapping module 240 determines, at operation 308, a performance goal from performance goals maintained may by the strategy management system 142 of FIG. 1 that corresponds to the objective determined at operation 304. At operation 310, the view generator 250 generates a combined view that includes performance data related to performance goals maintained by the strategy management system 142, as well as risk data aggregated for each objective that corresponds to at least one performance goal. An example sequence of events occurring in the process of aggregating risk in an enterprise strategy and performance management system is illustrated in FIG. 4.

FIG. 4 is a flow chart illustrating a method 400 for risk-adjusted strategy monitoring, in accordance with an example embodiment.

The method 400 may be performed by processing logic that may comprise hardware (e.g., dedicated logic, programmable logic, microcode, etc.), software (such as run on a general purpose computer system or a dedicated machine), or a combination of both. The processing logic, according to example embodiments, may reside in any of the modules shown in FIG. 1 and FIG. 2.

As shown in FIG. 4, the method 400 commences with operation 402, where the performance-related metrics are loaded in the strategy management system 142 of FIG. 1. Specifically, the performance related metrics data for KPIs may be loaded into a multidimensional data cube maintained by the strategy management system 142. In one example embodiment this operation may be performed as part of strategy management core activities. Example metrics data may include target quantitative values for the individual KPIs planned in advance as a result of the strategic planning process, as well as actual quantitative values loaded or entered into the strategy management system 142 according to a predetermined schedule (e.g., at the end of a pre-defined measurement period). Other virtual metrics, including score values and trend values, may be calculated in addition to and based on the actual and target values, using pre-defined rules and complementing the metrics set of a respective KPI. Shown below is an example of a metrics set of a KPI for “Net Sales” for December 2007 for Organizational Unit “Corporate.”

Target=$7,000,000

Actual=$5,900,000

Score (calculated as Actual/Target*100)=84

Trend (compared to previous period)=decreasing

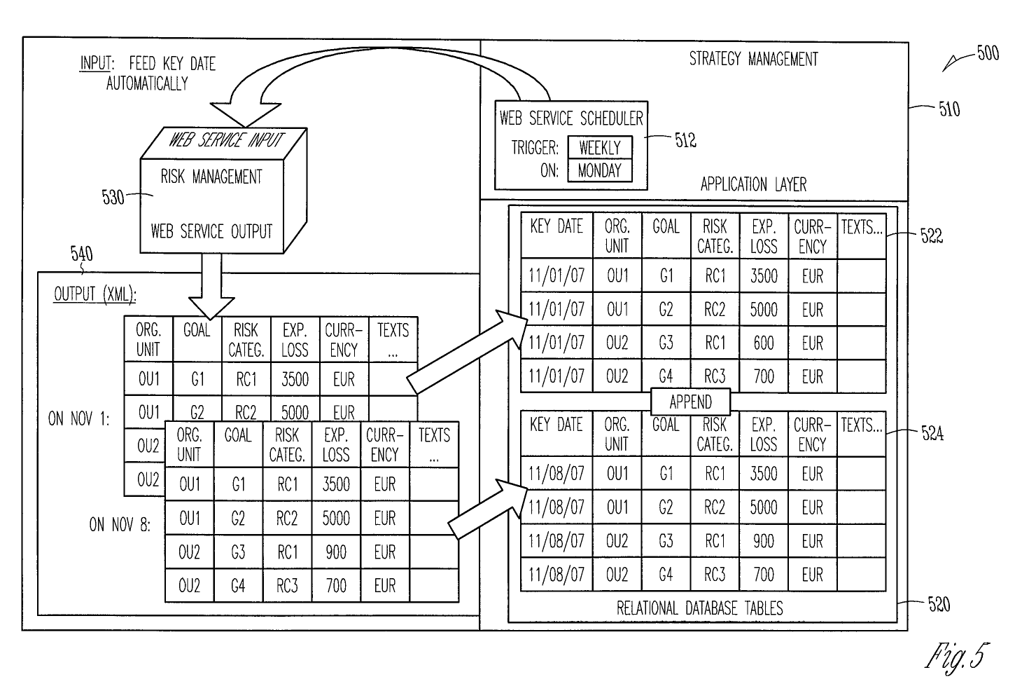

At operation 404, the integration system 146 of FIG. 1 obtains risk data from the risk management system 144 of FIG. 1 and stores in a relational database (e.g., the strategy database 150 associated with the strategy management system 142, both of FIG. 1). The details of this operation may be discussed with reference to FIG. 5.

FIG. 5 is a diagrammatic representation of an architecture 500 for a process to bring risk data into the context of strategy management. As shown in FIG. 5, a strategy management component 510, a database component 520, and a risk management component 530 cooperate to enhance the display of performance data with risk data. The strategy management component 510, the database component 520, and the risk management component 530 may correspond to the strategy management system 142, the risk management system 144, and the strategy database 150 of FIG. 1. In one example embodiment, risk data may be brought from data from the risk management component 530 by running a web service. While the web service is shown in FIG. 5 as running in the risk management component 530, it will be appreciated that such web service may be provided with the strategy management component 510 or as part of a stand-alone integration module. As shown in FIG. 5, the web service provided with the risk management component 530 communicates using eXtensible Markup Language (XML) (e.g., by generating an output 532, and may be configured with an extractor code and an associated wrapper. The extractor code may comprise programmed logic to automatically walk through individual risk exposure values stored by the risk management component 530, retrieve the risk exposure values and aggregate the risk exposure values at the objective level by the highest level risk categories. The wrapper may contain a universal resource locator (URL) address, as well as input/output schemes. The URL address may be utilized to permit a consumer to access the web service and the associated input/output schemes, e.g., via a Wireless Digital Subscriber Link (WDSL).

The execution of the web service is triggered, in one example embodiment, by a web service scheduler 512. The web service scheduler 512 may be implemented as part of the strategy management component 510. A web service consumer as an application logic wrapper may be associated with the web service scheduler 512 in strategy management component 510. When the scheduled execution time/date is reached, the web service consumer connects to the web service, e.g., using the log-on data such as user ID and password. The log-in data may identify the web service consumer as a system user authorized in the risk management component 530 to perform reporting (which may implicitly include the authorization to run the extractor). The web service consumer provides the current date (key date) as an input parameter in order to execute the web service. The extractor, as part of the web service, retrieves risk exposure values, aggregates them by the key date, and fills the output structure 530. The web service consumer receives the risk exposure values aggregated by the key date, automatically appends the key date as a field in an appropriate data set and writes the data in the relational database tables (or merely relational database) 540 associated with the strategy management component 510. As shown in FIG. 5, the risk exposure data associated with the key date of November 1 in the output 530 is used to generate a table 522 in the relational database 540. The risk exposure data associated with the key date of November 2 in the output 530 is used to generate a table 524 in the relational database 540. If previous records exist in the relational database 540, the new set of records is appended, using the key data field as a differentiator. For example, the table 524 in the relational database 540 is appended to the table 522.

As mentioned above, the extractor provided with the web service may be configured to include aggregation logic. The aggregation logic, in one example embodiment, provides a desired level of association between risk data and performance data. Aggregation logic may be utilized to calculate a simple set of risk exposure indicators by the highest level risk categories, as discussed below. Risk categories are often defined by risk managers or other users of a risk management system. Examples risk categories include, e.g., market risk, operating risk, and legal risk. Individual risk exposure values in a risk management system may be assigned to different categories there. In one example embodiment, risk exposure values associated with a particular risk category may be aggregated (e.g., mathematically added) to calculate an aggregated risk exposure value at the risk category level. If a risk category is defined as a hierarchical structure, only the highest level may be selected for aggregation and any lower levels may be ignored.

One example of applying the aggregation logic is provided below. Table 1 shows data records as stored for use by the risk management component 530. Individual risks may be distinguished (e.g., as R1, R2, etc.) and the risk exposure values (identified in Table 1 as “Expected Loss after Response”) may be documented for each individual risk. Each risk may be assigned to an objective. An objective may be specific to an organizational unit (e.g., OU1, OU2, etc.). Time dimension is represented by the “Period” column.

TABLE 1

| | | | | | Risk Exposure | |
|---|---|---|---|---|---|---|
| | | | | | (Expected Loss | |
| Period | Org. Unit | Risk | Risk Category | Objective | after Response) | Currency |
| 007.2007 | OU1 | R2 | Market | OU1/O2 | 500.000 | USD |
| 007.2007 | OU1 | R3 | Legal | OU1/O1 | 230.000 | USD |
| 007.2007 | OU1 | R4 | Legal | OU1/O1 | 750.000 | USD |
| 007.2007 | OU1 | R5 | Legal | OU1/O3 | 120.000 | USD |
| 007.2007 | OU1 | R6 | Operational | OU1/O1 | 340.000 | USD |
| 007.2007 | OU1 | R7 | Operational | OU1/O2 | 750.000 | USD |
| 007.2007 | OU1 | R8 | Operational | OU1/O3 | 3.400.000 | USD |
| 007.2007 | OU1 | R9 | Strategic | OU1/O3 | 2.340.000 | USD |
| 007.2007 | OU1 | R10 | Market | OU1/O1 | 210.000 | USD |
| 007.2007 | OU1 | R11 | Market | OU1/O1 | 640.000 | USD |
| 007.2007 | OU1 | R12 | Legal | OU1/O2 | 460.000 | USD |
| 007.2007 | OU2 | R13 | Operational | OU2/O1 | 2.400.000 | USD |
| 007.2007 | OU2 | R14 | Operational | OU2/O2 | 250.000 | USD |
| 007.2007 | OU2 | R15 | Operational | OU2/O4 | 260.000 | USD |
| 007.2007 | OU2 | R16 | Strategic | OU2/O2 | 1.200.000 | USD |
| 007.2007 | OU2 | R17 | Strategic | OU2/O3 | 340.000 | USD |
| 007.2007 | OU2 | R18 | Strategic | OU2/O1 | 360.000 | USD |
| 007.2007 | OU2 | R19 | Market | OU2/O2 | 850.000 | USD |
| 007.2007 | OU2 | R20 | Legal | OU2/O2 | 930.000 | USD |
| 007.2007 | OU2 | R21 | Legal | OU2/O2 | 340.000 | USD |

The output generated by the web service based on the data from Table 1 is represented in Table 2 below. The results shown in Table 1 are aggregated by the extractor logic and filled in an output structure of the web service. The individual risks are not included in Table 2 and the risk exposure values are aggregated by organizational unit, Objective, Period (Key Date), and Risk Category.

TABLE 2

| | | Risk Exposure aggregated | | | |
|---|---|---|---|---|---|
| | | by Risk Category as of 007.2007 | | | |
| Org. Unit | Objective | Legal | Market | Operational | Strategic |
| OU1 | OU1/O1 | | | | |
| OU1 | OU1/O1 | 980.000 | 850.000 | 340.000 | |
| | OU1/O2 | 460.000 | 500.000 | 750.000 | |
| | OU1/O3 | 120.000 | | 3.400.000 | 2.340.000 |
| OU2 | OU2/O1 | | | 2.400.000 | 360.000 |
| | OU2/O2 | 1.270.000 | 850.000 | 250.000 | 1.200.000 |
| | OU2/O3 | | | | 340.000 |
| | OU2/O4 | | | 260.000 | |

Returning to FIG. 4, at operation 406, a mapping utility is run to associate the obtained elements of risk data with objectives maintained by the strategy management component 510 of FIG. 5. As a result, all obtained risk management dimension members may be stored in an appropriate dimension of a data cube maintained by the strategy management component 510. Example data mapping systems and methods may be established in the strategy management component 510 to permit integration between strategy management and risk management. The integration concept may utilise the hierarchy of organizational units and the notion of a strategic objective being shared by both strategy management and risk management. As mentioned above, strategy management may use objectives to cascade down strategic business goals along the organizational hierarchy. Risk management, on the other hand, may use a simplified notion of an objective as the structure assigned to the organizational hierarchy to relate the business risks to. The entities used in the two systems may have different text labels and/or different identifiers even when they refer to the same object (e.g., the same organizational unit may have different labels in a strategy management system and in a risk management system). At operation 406, a mapping table may be used to translate the entity naming convention used in risk management to the naming convention used in strategy management.

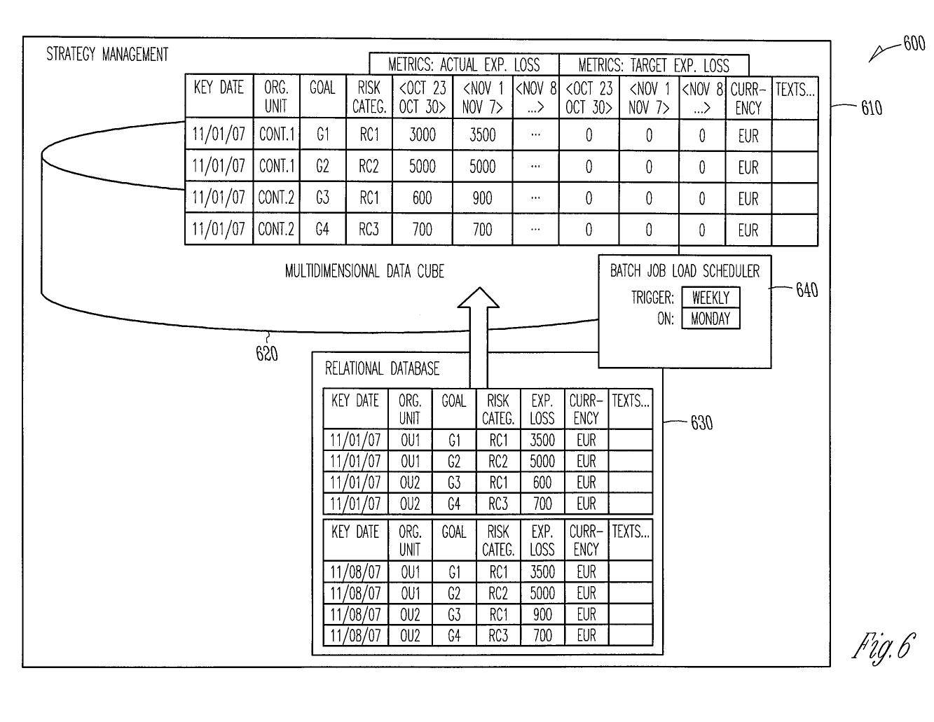

At operation 408, the risk data obtained at operation 404 and stored in the relational database 520 of FIG. 5 is loaded into one or more data cubes maintained by the strategy management component 510 of FIG. 5. Example operation to load more data cubes maintained by the strategy management component 510 with the risk data may be discussed with reference to FIG. 6. FIG. 6 is a diagrammatic representation of an architecture 600 for a process to load a data cube used by a strategy management system with risk data, in accordance with an example embodiment.

As shown in FIG. 6, the architecture 600 includes a strategy management component 610 configured to maintain a multidimensional data cube 620. The multidimensional data cube 620 may be constructed based on data from a relational database 630. The multidimensional data cube 620 may be optimized for analytical reporting across multiple dimensions and time. In one example embodiment, the strategy management component 610 includes a scheduler 640 to schedule a load operation from the relational database 630 to the multidimensional data cube 620. The multidimensional data cube 620, in one embodiment, serves as the final data storage for the KPIs metrics sets. The metrics sets (including, e.g., Actual, Target, Score, Trend etc.) may be displayed via a user interface of the strategy management component 610. Thus, in one embodiment the core capability of the strategy management component 610 to model KPIs may be utilized as a vehicle to model a new indicator—the risk exposure Indicator—at the objective level.

In order to load the multidimensional data cube 620 with risk data, one or more mapping tables are accessed to determine corresponding objectives' labels used by the strategy management component 610 and a risk management system. The risk data obtained from the risk management system and stored in the relational database 630 is written to populate appropriate dimension members of the correctly to the proper dimension members multidimensional data cube 620. As mentioned above, the risk data provided to the strategy management component 610 and modeled into the multidimensional data cube 620 may include target risk exposure values, as well as actual risk exposure values. The target risk exposure values may be set to zero as a default or to some positive value (e.g., where an organization is willing to tolerate a certain level of risk exposure). The actual risk exposure values may be compared to the target risk exposure values in the context of strategy and performance management, in order to evaluate performance goals and strategy objectives. As shown in FIG. 6, the strategy management component 610 may include a scheduler 640 that may be configured to trigger the load of data the multidimensional data cube 620, e.g., based on predefined date and time parameters.

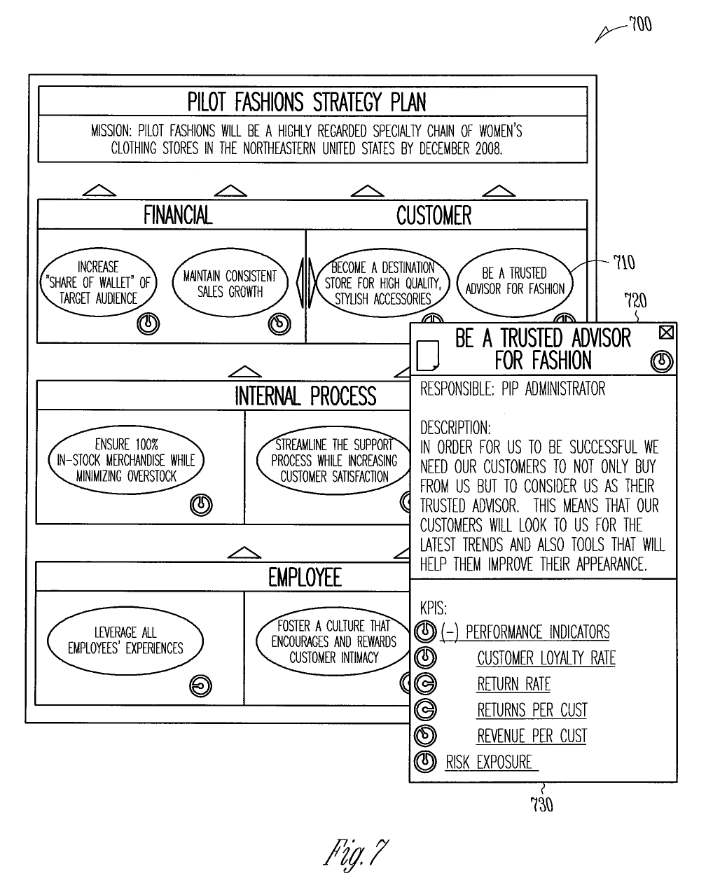

Returning to FIG. 4, at operation 410, risk exposure indicators are created in the strategy management system. Risk exposure indicators may be created at an objective level and presented in the context of a strategy management system. FIG. 7 is a diagrammatic representation of a user interface 700 to display strategy management data, in accordance with an example embodiment. As shown in FIG. 7, the user interface 700 presents various objectives, including an objective (or a performance goal) 710. The objective 710 may be presented in a way to permit a user to activate presentation of a detail window 710. The detail window 720 shows operational KPIs and an associated risk exposure indicator.

Operational KPIs and a risk exposure indicator associated with a particular objective (e.g., the objective 710) may be used to determine one or more performance status indicators (or indices). A performance status indicator may indicate the status of a performance goal, e, g., utilizing a pre-defined color- or shape-coding. In one example embodiment the colors red, yellow, and green may be associated with worst case, average, and weighted average respectively. Performance status indicators may provide an end user with a balanced view of the objective, considering past performance (the operational KPIs) as well as potential risks (the risk exposure indicator), as illustrated by data shown in the detail window 720. Example approach for capturing and consolidating operational KPIs and risk exposure indicators into an objective includes first generating a risk exposure indicator and then assigning individual performance KPIs to a single KPI, using the so-called index KPI capability of the strategy management system. This single index KPI (shown in FIG. 7 as element 722) may be the result of the aggregation of the performance status indicators for all operational KPIs associated with the objective into a single view. A single index KPI may be used to permit the end user to clearly distinguish between performance status and the risk exposure that may affect the performance status in the future. As shown in FIG. 7, the index 722 of the objective 710 “Be a trusted advisor for fashion” is driven by KPIs that include a risk exposure indicator.

A risk exposure indicator may be created (e.g., automatically or manually) for each objective maintained in the risk management system as a risk attribute, thus being risk-sensitive. A risk exposure indicator may be created utilizing KPI modeling capability of a strategy management system. For example, in creating a risk exposure indicator, a descriptive text label may be used (e.g., ‘Risk Exposure#), a risk-related KPI type attribute may be used (e.g., “Risk” instead of “Operational”). A risk exposure indicator may be then connected to the respective metrics set containing risk exposure data (instead of connecting it to the performance data). A KPI type of Risk/Operational may be generated. In one example embodiment, the process to generate risk exposure indicators uses implicit aggregation capability of the multidimensional data cube maintained by the strategy management system in order to calculate a single indicator at an objective level for the selected key date (e.g., by adding up risk exposure indicators for the respective risk categories). Detailed risk exposure indicators may remain stored by the strategy management system and may be presented in response to a request by a user decides to perform drill-down by risk category.

A drill down operation may be performed as part of operation 412 of FIG. 4, where risk-adjusted strategy monitoring is being performed. A user of the strategy management system may be allowed to analyze the performance status of an objective (designated, e.g., by red, yellow, and green symbols), review operational KPIs as influencing factors, but also have visual representation of the impact of the aggregated risk exposure. For example, if the risk exposure indicator demonstrates some negative trends (e.g., the overall risk exposure increasing), the user may determine that it may be beneficial to analyze the root causes by drilling down by risk category (as the last granularity level of the risk data extracted to strategy management at operation 404 of FIG. 4). A dedicated link to the risk management system may be provided in the user interface of the strategy management system. Such dedicated link may be maintained at the objective level as a URL address, linking over to an appropriate report in the risk management system, such that to permit users to quickly obtain more detail on the risk data summarized in the risk exposure indicator. As shown in FIG. 7, a risk exposure item 730 may be provided with a link to associated information in the risk management system.

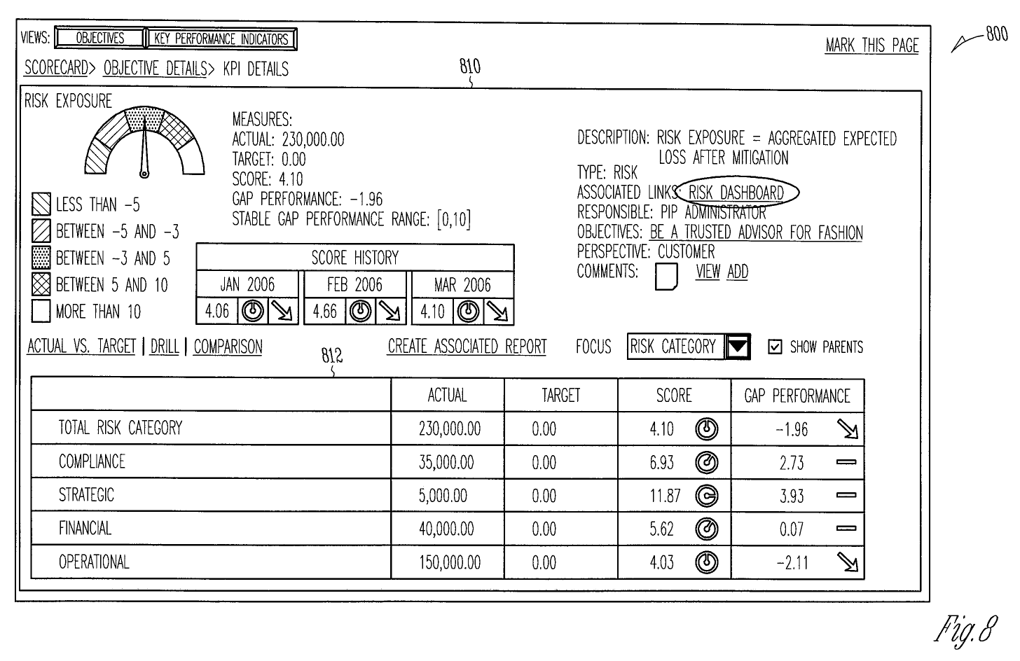

FIG. 8 is a diagrammatic representation of a user interface 800 to display a scorecard that incorporates risk data, in accordance with an example embodiment. As shown in FIG. 8, the user interface 800 includes a risk exposure display area 810. Within the risk exposure display area 810, a user may view risk exposure values arranged by risk category in a display area 812.

As can be seen in the area 812, in the column that displays “Score” values, each value is accompanied by an index symbol. Each index symbol indicates whether the associated value is acceptable (a circle with a line extending from the center to the left, graphically between 6 o'clock and 12 o'clock), warranting a warning (a circle with a line extending from the center, graphically, at 12 o'clock), or unacceptable (a circle with a line extending from the center to the right, graphically between 6 o'clock and 12 o'clock). Each index symbol may also be associated with a color to indicate that the associated value is acceptable (green), warranting a warning (yellow), or unacceptable (red). Performance and risk indicators may be associated with one or more predetermined and configurable thresholds. E.g., if a certain KPI or a certain risk indicator reaches a certain configurable threshold, the associated index symbol and/or color may be changed (e.g., from green-to yellow-to red). It will be appreciated that various other graphical indicators and color schemes may be used to indicate whether the associated value is acceptable, warranting a warning, or unacceptable.

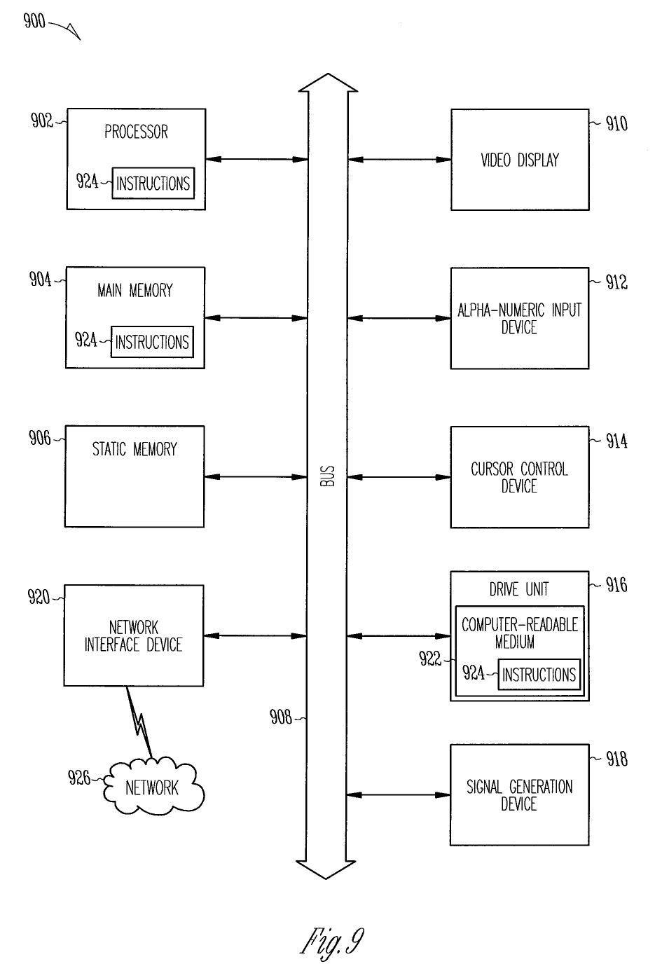

FIG. 9 is a diagrammatic representation of a machine in the example electronic form of a computer system 900 within which a set of instructions, for causing the machine to perform any one or more of the methodologies discussed herein, may be executed.

In various embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an “Moving Picture Experts Group (MPEG) Layer 3” (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions and data structures (e.g., software 924) embodying or utilized by any one or more of the methodologies or functions described herein. The software 924 may also reside, completely or at least partially, within the main memory 904 and/or within the processor 902 during execution thereof by the computer system 900, the main memory 904 and the processor 902 also constituting machine-readable media.

The software 924 may further be transmitted or received over a network 926 via the network interface device 920 utilizing any one of a number of well-known transfer protocols (e.g., Hyper Text Transfer Protocol (HTTP)).

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Such medium may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Thus, a data-driven system for fast response to security vulnerability have been described. Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A system comprising:
a risk fetching module to obtain risk exposure data, the risk exposure data related to one or more objectives;
a risk data parser to determine a first objective from the one or more objectives;
a selector to determine source risk exposure values from the risk exposure data, the source risk exposure values being related to the first objective;
an aggregator to aggregate the source risk exposure values related to the first objective into an aggregated risk value;
a mapping module to determine a performance goal corresponding to the first objective; and
a view generator to generate a combined view to include performance data related to the performance goal and the aggregated risk value.

2. The system of claim 1, wherein the aggregated risk value is related to actual risk exposure.

3. The system of claim 1, wherein the aggregated risk value is related to target risk exposure.

4. The system of claim 1, comprising a goal status monitor to generate a goal status indicator based on the aggregated risk value and one or more performance indicators related to the performance goal.

5. The system of claim 4, wherein the goal status monitor is to associate a color with the goal status indicator.

6. The system of claim 1, comprising:
a strategy database to store data related to performance and strategy; and
a database loader module to load the aggregated risk value into the database.

7. The system of claim 1, comprising:
receiving a request to display performance-related metrics; and
displaying the combined view.

8. The system of claim 1, comprising generating the combined view to permit drilling down to view the source risk exposure values.

9. The system of claim 1, comprising generating the combined view to include a link to a risk management system that maintains the source risk exposure values.

10. A method comprising:
obtaining risk exposure data, the risk exposure data related to one or more objectives;
determining a first objective from the one or more objectives;
determining source risk exposure values from the risk exposure data, the source risk exposure values being related to the first objective;
aggregating the source risk exposure values related to the first objective into an aggregated risk value;
determining a performance goal corresponding to the first objective; and
generating a combined view to include performance data related to the performance goal and the aggregated risk value.

11. The method of claim 10, wherein the aggregated risk value is related to actual risk exposure.

12. The method of claim 10, wherein the aggregated risk value is related to target risk exposure.

13. The method of claim 10, comprising generating a goal status indicator based on the aggregated risk value and one or more performance indicators related to the performance goal.

14. The method of claim 13, comprising associating a color with the goal status indicator.

15. The method of claim 10, comprising:
preloading a multi-dimensional cube with the aggregated risk value and the one or more performance indicators; and
generating the combined view utilizing the multi-dimensional cube.

16. The method of claim 10, comprising:
receiving a request to display performance-related metrics; and
displaying the combined view.

17. The method of claim 10, comprising generating the combined view to permit drilling down to view the source risk exposure values.

18. The method of claim 10, comprising generating the combined view to include a link to a risk management system that maintains the source risk exposure values.

19. A machine-readable medium may be provided having instruction data to cause a machine to:
obtain risk exposure data, the risk exposure data related to one or more objectives;
determine a first objective from the one or more objectives;
determine source risk exposure values from the risk exposure data, the source risk exposure values being related to the first objective;
aggregate the source risk exposure values related to the first objective into an aggregated risk value;
determine a performance goal corresponding to the first objective; and
generate a combined view to include performance data related to the performance goal and the aggregated risk value.

20. A system comprising:
a strategy management module to maintain performance data;
a risk management module to maintain risk exposure data; and
an integration module to aggregate the risk exposure data obtained from the risk management module to generate objective-based aggregated risk values and to model a combined view, the combined view to associated the performance data with the objective-based aggregated risk values.
